(19) United States
(12) Patent Application Publication
(10) Pub. No.: US 2013/0069766 A1
(43) Pub. Date: Mar. 21, 2013

(54) Hand-Held Security Alarm System

(71) Applicant: Keith Marlowe Sorge, Plymouth, MN (US)

(72) Inventor: Keith Marlowe Sorge, Plymouth, MN (US)

(21) Appl. No.: 13/238,522

(22) Filed: Sep. 21, 2011

(51) Int. Cl. G08B 21/02

(52) U.S. Cl. 340/6.1

(57) ABSTRACT

A hand-held security alarm system for sounding an alarm when the system is released. The hand-held security alarm system includes a hand-held device that contains an alarm, a battery, an activation member, an activation electronic circuit, an alarming member, and a deactivation button. The activation member being biased to push away from the hand-held device by a compression spring. The activation electronic circuit being activated by an activation switch when the activation member travels a certain distance from the hand-held device. The hand-held device is maintained in the inactive state by the activation member being held against the hand-held device by a detent incorporated into the alarming member. The hand-held device is put into the armed position by sliding the alarming member so that the detent on the activation member travels past a catch on the activation member and the activation is held against the compression spring by an external force such as a hand grasping the hand-held device. The hand-held device once armed is activated by releasing the external force on the activation member so that the compression spring pushes the activation member away from the hand-held device thereby triggering the electronic circuit and causing the battery to energize the alarm causing an audible sound. The electronic circuit cannot be deactivated by pressing the activation member back towards the hand-held device but requires the application of a deactivation switch which when pushed opens the electronic circuit cutting the battery power from the alarm. The hand-held device includes a strap that can be securely attached to the body of the user so that in an attack the hand-held device stays with the user.

### FIELD OF THE INVENTION

The present invention relates generally to alarm systems and more specifically to a hand-held security alarm system for the purpose of sounding an alarm when a device held in the hand is released by the user. The device can be incorporated into a system using a security warning company service so that when the alarm is activated the security warning company can contact and locate the user to verify the user's status and direct police in response if necessary.

### BACKGROUND OF THE INVENTION

Alarm systems have been in use for years. Typically, they involve a device that the user carries or has on the user's person. The user is required to activate the alarm contained in the device by pulling a pin, or triggering a switch or by some other active act by the user. The problem with these devices is that when the user is attacked by surprise the user may not have the ability or time to activate the alarm.

For example, a user may be attacked by an assailant walking in the opposite direction giving no indication that he is going to attack. In this situation the user could be knocked unconscious before the user realized an attack was imminent. If the user is knocked unconscious the user would be unable to activate a prior art alarm.

Prior art also include satellite-tracking systems. These systems are often seen in fleet tracking systems that allow a company to monitor the location of its fleet of vehicles.

Prior art further includes systems that allow the user, when the user activates a device, to have the user's location identified using a global positioning tracking system.

These systems described in the prior art do not, however, provide a mechanism whereby the user can passively activate the system by letting go of the device, having the device automatically contact the security warning company wherein the security warning company can confirm whether the user has activated the system on purpose or by accident. With this verification capability if the device is activated inadvertently the security warning company will not notify police service and thereby an activation of the device by accident will not result in an emergency response thereby not wasting valuable police services time and resources.

### SUMMARY OF THE INVENTION

In view of the foregoing disadvantages inherent in the known types of hand-held security alarm systems now present in the prior art, the present invention provides a new hand-held security alarm system wherein a user can activate the alarm by simply letting go of the device.

The general purpose of the present invention, which will be described subsequently in greater detail, is to provide a new hand-held security alarm system that has many of the advantages of the prior art mentioned heretofore and many novel features that results in a new hand-held personal alarm system which is not anticipated, rendered obvious, suggested, or even implied by any of the prior hand-held personal alarm systems, either alone or in any combination thereof.

To attain this, the present invention generally comprises a personal alarm system that when the device is set to the armed position the activation member is spring-loaded and must be held in the closed position to keep the alarm from activating. When the device is released by the user the activation member springs into the open position and the alarm is activated.

Once the personal alarm is activated it cannot be deactivated by pressing or squeezing the activation member back into the device. The personal alarm requires a mechanical or electrical code to be entered to allow deactivating the device.

In one embodiment of the hand-held security alarm system the device includes a means of transmitting a signal to a personal and home security company. Upon activation, the personal and home security company attempts to contact the user's cell phone to ascertain whether the user is in danger. If the user fails to answer the call from the personal and home security company, then the home security company determines the location of the personal alarm device by analyzing the global position system (“GPS”) signal being transmitted by the device. Once the location is determined the personal and home security company contacts local police authorities notifying them of the alarm activation and the location of the alarm.

In another embodiment the personal alarm is incorporated into a cellular phone. In this embodiment the cellular phone's keypad can be used to activate and deactivate the alarm. In this embodiment the user does not need to carry both a personal alarm and their cell phone to include the ability to facilitate the interaction with a personal and home security system.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood the phraseology and terminology employed herein are for the purpose of the description and should not be regarded as limiting.

A primary object of the present invention is to provide a hand-held security alarm system that will overcome the shortcomings of the prior art devices.

A second object is to provide a hand-held security alarm system that activates by simply releasing the system.

A further object is to have a hand-held security alarm system that integrates a global positioning system (“GPS”) to identify the location of the hand-held device.

A further object is to have a hand-held security alarm system that integrates a security service company to verify the status of the user of the device.

A further object is to have a hand-held security alarm system that integrates a security service company to verify the status of the user of the device and to contact local police authorities and relay that information if the user does not respond to attempts to contact the user by the security service company.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other object, features and attendant advantages of the present invention will become fully appreciated as the same becomes better understood when considered in conjunction with the accompanying drawings, in which like reference characters designate the same or similar parts throughout the several views, and wherein:

FIG. 1 is a upper perspective view of the present invention.

FIG. 2 is a top view of the present invention with the device in the unarmed position.

FIG. 3 is a top exploded view of the present invention with the device in the activated position.

FIG. 4 is a top exploded view of the present invention with the device in the unarmed position.

FIG. 5 is a side view of the present invention with the device in the armed but deactivated position.

FIG. 6 is a schematic of the architecture of an embodiment of the present invention providing emergency location and response capabilities.

### DETAILED DESCRIPTION

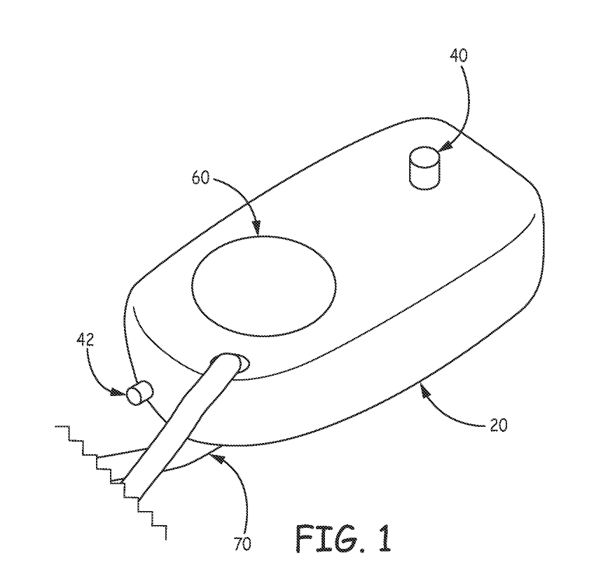

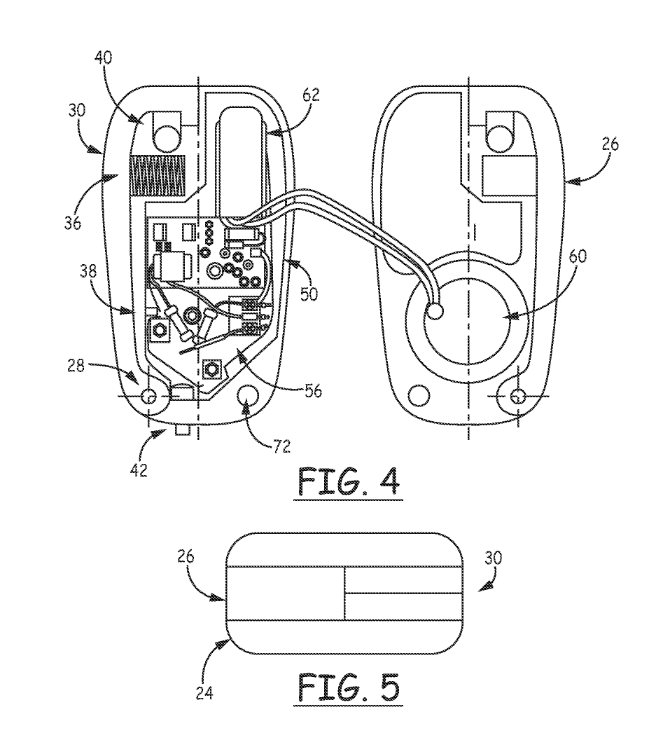

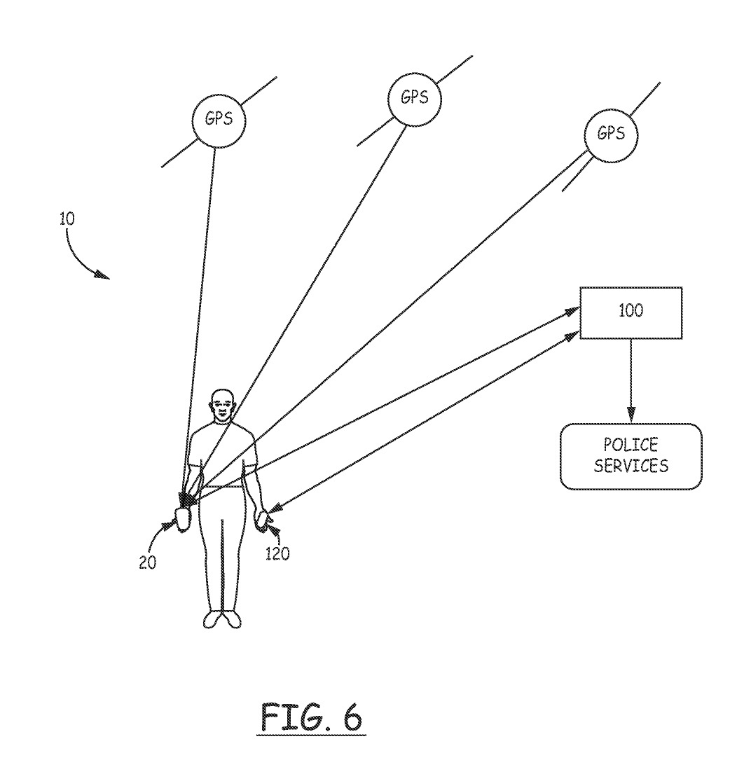

Turning now descriptively to the drawings, in which similar reference characters denote similar elements throughout the several views, FIGS. 1-6 illustrate a hand-held security alarm system 10, which comprises a hand-held device 20, with an activation member 30 which is set in the active mode by engaging an alarming member 40. When the activation member 30 is released, an activation spring 36 forces the activation member 30 away from the hand-held device 20. Once the activation member 30 reaches a certain distance from the hand-held device 20, an activation circuit 50 is closed and an alarm 60 activates with an audible sound powered by a battery 62. A connecting strap 70 is attached to the hand-held device 20 at connection opening 72. In use the connecting strap 70 is secured to the user's wrist.

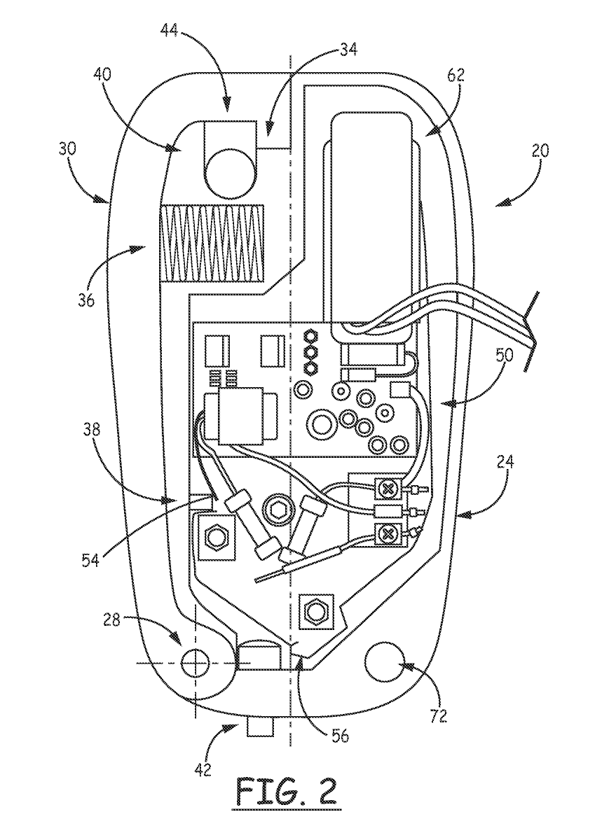

As best illustrated in FIGS. 2, 3, and 4 the hand-held device 20 preferably comprises a semi-hollow housing 22 comprised of a bottom housing 24 and a top housing 26. The bottom housing 24 and top housing 26 are connected with screws 74 or other comparable securing mechanism. Contained within the semi-hollow housing 22 are the battery 62, the activation spring 36, the activation circuit 50, an activation trip pin 38, and the alarming member 40.

The activation member 30 is pivoted on housing 22 by a pivot pin 28. The activation member 30 also includes a activation member catch 34. The alarming member 40 has a detent 44 that normally holds the activation member 30 in a closed, deactivated position and with the activation spring 36 compressed as shown in FIG. 2. In this closed, deactivated position of member 30, detent 44 is located in the same plane as activation member catch 34 so that one side of detent 44 abuts with activation member catch 34. However, the alarming member 40 is slidable relative to housing 22. When the alarming member 40 is selectively depressed by the user by pushing alarming member 40 towards housing 22, both button 40 and detent 44 are depressed together with the detent 44 sliding past the activation member catch 34 of the activation member 30 until detent 44 has cleared the plane of activation member catch 34, thus freeing member 30 for movement. Unless the activation member 30 is then held fast against the hand-held device 20 by the user, the compressed spring 36 will push the activation member 30 away from the housing 22 of hand-held device 20.

Attached to the activation member 30 is a trip pin 38. When the activation member 30 is in the closed position, the trip pin 38 is in contact with circuit-on switch 54. Referring to FIG. 2, one can see that the bottom of trip pin 38 abuts against the top end of switch 54 to make such contact. The circuit-on switch 54 is preferably a conductive metal spring biased to travel towards the activation member 30.

In use the user secures the connecting strap to the user's wrist. The user holds the hand-held device 20 in his hand ensuring the hand covers the activation member 30. The user then pushes the alarming member 40 so that the detent 44 slides past and out of contact with the activation member catch 34. The alarming member 40 is held in the depressed state by means know in the art to include friction. The user must keep sufficient pressure on the activation member 30 so that the activation spring 36 stays compressed. At this point the user has armed the hand-held device 20.

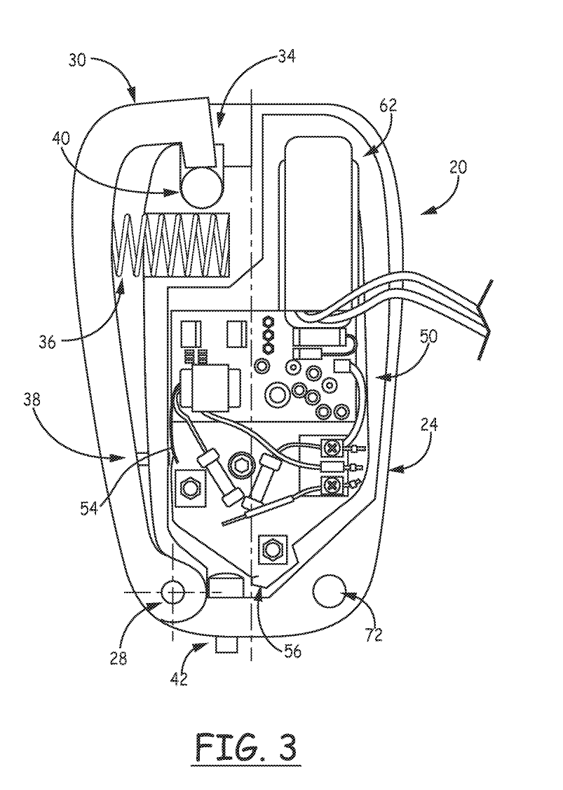

In this armed condition, when the activation member 30 of the hand-held device 20 is released by the user by removing pressure from the activation member 30, the activation spring 36 decompresses pivoting the activation member 30 about the pivot 28 to a position further away from the semi-hollow housing 22. As the activation member 30 travels away from the semi-hollow housing 22, the trip pin 38 also moves away from the semi-hollow housing 22. As the trip pin 38 moves away from the semi-hollow housing 22 it moves up off of switch 54 to break contact therewith as shown in FIG. 3. Thus, the circuit-on switch 54 closes the activation circuit 50 and power from the battery 36 energizes the alarm 60 creating an audible sound. The alarm 60 is preferably a piezo-electric element that converts the electricity provided by the battery 36 into mechanical sound waves.

It is preferred that the hand-held security alarm system 10 cannot be deactivated by simply pressing the activation member 30 toward the semi-hollow housing 22. This preference is designed into the hand-held security alarm system 10 so that the assailant cannot easily render the hand-held security alarm system 10 inoperable. Therefore the preferred embodiment's activation circuit 50 cannot be opened by causing the trip pin 38 to push the circuit-on switch 54 away from its electrical contact point that originally closed the activation circuit 60. Once the activation circuit 50 is closed the activation circuit 50 can only be opened by pressing a reset button 42 in towards the semi-hollow housing 22. The reset button 42 pushes on a circuit-off switch 56, which breaks the circuit thereby, opening the activation circuit 50. Once the activation circuit 50 is opened the user squeezes the activation member 30 back towards the semi-hollow housing recompressing the activation spring 36. The user then pushes the alarming member 40 in thereby causing the detent 44 to slide into restricting contact with the activation member catch 34. The hand-held device 20 is now in the closed deactivated position.

To deactivate the hand-held device 20 when the activation circuit 50 is closed and has never been opened, as when the user is in a safe environment, the user pushes the alarming member 40 in thereby causing the detent 44 to slide into restricting contact with the activation member catch 34. The hand-held device 20 is now in the closed deactivated position.

The hand-held security alarm system 10 in one embodiment includes the ability for the hand-held device's 20 location to be located using tracking technology. In this embodiment the hand-held device includes a global positioning system receiver and transmitter. This technology is currently used in fleet tracking GPS system and well known in the prior art.

To further enhance this embodiment of the hand-held security system 10 the hand-held security system 10 incorporates a security providing company 100 similar to a home security system such as ADT Security Services. In this embodiment of the hand-held security system 10 the user acquires a membership with a security providing company 100. The user provides the security providing company 100 with the user's cell phone 120 number. The user and the security providing company 100 prearrange security codes 130 that the user will use to inform the security providing company 100 whether the user is safe or that the user is in trouble. For example, the security providing company will ask the user the user's status. If the user answers with the code October, then the user is not in danger. If the user answers with November then the user is in trouble.

In use in this embodiment the user arms the hand-held device 20. If the alarm 60 is activated GPS receiver/transmitter 110 in the hand-held device 20 sends a warning signal to the security providing company 100. By using the GPS tracking capability in the GPS receiver/transmitter 100 in the hand-held device 20 the security providing company 100 can determine the location of the activated hand-held device. The security providing company 100 then contacts the user's previously stored cell phone 120 number. If the user's activation of the hand-held device 20 was inadvertent the user answers the user's cell phone 120 and provides a security code 130 to let the security providing company know that the user is in no danger and that the activation of the hand-held device 20 was inadvertent. If the user's activation of the hand-held device 20 was done on purpose the user answers the user's cell phone 120 and provides a security code 130 to let the security providing company 100 know that the user is in danger. If the user fails to answer the user's cell phone 120, then the security providing company 100, contacts local police authorities to inform the police authorities of the emergency activation of the hand-held device 20 and the current location of the hand-held device 20.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated n the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A hand-held security alarm system, comprising
a hand-held device comprising a semi-hollow body;
a battery and alarm circuit inside the semi-hollow body;
an activation member movably carried on the semi-hollow body and biased to push away from the semi-hollow body;
an arming member that incorporates a detent to restrict the activation member from biasing away from the semi-hollow body until the detent is moved by the user to a disengaged position relative to the activation member to free the activation member for movement caused by the bias applied thereto to thereby arm the device; and
an activation switch that energizes the alarm circuit.

2. A hand-held security alarm system of claim 1, wherein
the activation member is biased to push away from the semi-hollow body by a spring.

3. A hand-held security alarm system of claim 1, wherein
a connecting strap is attached to the semi-hollow body.

4. A hand-held security alarm system of claim 1 wherein the activation member is a pivotal lever.

5. A hand-held security alarm system of Claim I wherein the alarming member is a depressible button.

6. A hand-held security alarm system of claim 1, further including a deactivation switch to disconnect the alarm system, and wherein the alarm circuit cannot be deactivated unless the deactivation switch is pressed.

7. A hand-held security alarm system, comprising
a hand-held device comprising a semi-hollow body;
a battery and alarm circuit inside the semi-hollow body;
an activation member movably carried on the semi-hollow body and biased to push away from the semi-hollow body;
an arming member that incorporates a detent to restrict the activation member from biasing away from the semi-hollow body until the detent is moved by the user to a disengaged position relative to the activation member to free the activation member for movement caused by the bias applied thereto to thereby arm the device; and
an activation switch that energizes the alarm circuit when the activation member is permitted to bias away from the semi-hollow body by the user releasing hand pressure from the activation member.

8. A hand-held security alarm system of claim 7, wherein
the activation member is biased to push away from the semi-hollow body by a spring.

9. A hand-held security alarm system of claim 7, wherein
a connecting strap is attached to the semi-hollow body.

10. A hand-held security alarm system of claim 7, further including a deactivation switch to disconnect the alarm system, and wherein the alarm circuit cannot be deactivated unless the deactivation switch is pressed.

11. A hand-held security alarm system of claim 7 wherein the activation member is a pivotal lever.

12. A hand-held security alarm system of claim 7 wherein the alarming member is a depressible button.

13. A hand-held security alarm system, comprising
a hand-held device comprising a semi-hollow body;
a battery and alarm circuit inside the semi-hollow body;
an activation member biased to push away from the semi-hollow body;
an alarming member that incorporates a detent to restrict the activation member from biasing away from the semi-hollow body;
an activation switch that energizes the alarm circuit when the activation member biases away from the semi-hollow body;
a deactivation switch to disconnect the alarm circuit; and
a global positioning system receiver/transmitter incorporated into the semi-hollow body.

14. A hand-held security alarm system of claim 13, wherein
the global position system receiver/transmitter can transmit the location of the semi-hollow body to a alarm-system monitoring station.

15. A hand-held security alarm system of claim 13, wherein
the alarm-system monitoring station can notify emergency response services.
